(19) United States
(12) Patent Application Publication
(10) Pub. No.: US 2003/0039402 A1
(43) Pub. Date: Feb. 27, 2003

(54) Method and apparatus for detection and removal of scanned image scratches and dust

(76) Inventors: David R. Robins, Newton, MA (US); Jong Chul Ye, Framingham, MA (US)

Correspondence Address: Orlando Lopez, POLAROID CORPORATION, Patent Department, 784 Memorial Drive, Cambridge, MA, 02139, US

(21) Appl. No.: 09/939,094

(22) Filed: Aug. 24, 2001

(51) Int. Cl. G06T 5/50; G06K 9/40; G06T 5/30; G06K 9/44; G06K 9/46; G06K 9/54

(52) U.S. Cl. 382/275; 382/262; 382/264; 382/257; 382/190; 382/282

(57) ABSTRACT

To avoid generating visible artifacts in the image, such as those generated when mildly defective areas are not identified, a system and method for identifying and correcting defects in a digital image including adjusting the pixel values of pixels surrounding the defective pixels are disclosed. The method for correcting defects in a input digital image comprises the steps of identifying the defects to form at least one defect map, generating a region of interest for each defect map, correcting the values of the pixels in each defect map, and adjusting the values of the pixels in each region of interest.

In one embodiment, the input digital image is filtered with a median filter to generate a filtered image. A difference image is generated by subtracting the filtered image from the input digital image, and the pixels at which the difference image pixel value exceeds a given threshold are identified as defect pixel locations. The defect maps are comprised of adjoining defect pixel locations. The pixel values at the defect pixel locations are replaced with the corresponding filtered image pixel values. A smoothing operation is applied to obtain the adjusted value of the pixels in each region of interest corresponding to each defect map. User input is utilized to further mitigate the effects of uncertainty in defect identification.

### CROSS REFERENCE TO RELATED APPLICATION

This application is related to commonly-owned and concurrently filed U.S. patent application Ser. No. aa/AAA, AAA entitled “Method and System for User Assisted Defect Removal” (Attorney Case No. 8519), which is hereby incorporated by reference in its entirety.

### BACKGROUND OF THE INVENTION

1. Field Of the Invention

The present invention relates to image processing. More specifically, it relates to the detection and removal of defects in a digital image.

2. Background of the Description

Digital images often contain information that differs from the original image. Such information that differs from the original image constitutes defects in the digital image. In some instances, defects are caused by the imperfections of the digital acquisition system. For example, obstructions in the optical system of the digital acquisition device can introduce defects. Some typical causes of obstructions are dust and scratches in components of the optical system.

Other sources of defects are imperfections and extraneous matter on the surface of the input image. For example, an input image could be scratched or deformed. Extraneous matter such as dust or particulates or fibers or fingerprints on the surface of the input image will be acquired as defects.

Since digital image processing techniques can be easily applied to a digital image, such techniques can be adapted to correct the defects in the image. A variety of image defect detection and correction methods have been applied.

Both hardware and software defect detection methods have been applied. Hardware defect detection methods include use of an infrared image channel to detect defects as in U.S. Pat. No. 5,266,805 (A. D. Edgar, “System and Method for Image Recovery”, Nov. 30, 1993) and in U.S. Pat. No. 6,075,590 (A. D. Edgar, “Reflection Infrared Surface Defect Correction”, Jun. 13, 2000). Another approach to defect detection using a second light source and the scattering properties of the image is described in WIPO Publication WO 00/46980 (M. Potucek et al., “Apparatus and Methods for Capturing Defect Data”, published Aug. 10, 2000). Both of these methods require additional hardware.

Defect correction methods comprise image processing. In U.S. Pat. No. 6,075,590, the output of a defect channel, obtained using the infrared image, is multiplied by a gain and subtracted from the visible image. In WIPO Publication WO 01/27688 A2 (A. D. Edgar et al., “System and Method for Correcting Defects in Digital Images Through Selective Filling From Surrounding Areas”, published Apr. 19, 2001), the defective pixels are replaced with values determined from a surrounding area of the image. In both of these methods, only the defective pixels are adjusted. Adjusting only the pixels identified as defective can lead to visible artifacts in the image if, for example, mildly defective areas are not identified.

### SUMMARY OF THE INVENTION

It is the primary object of this invention to provide a system and method for identifying and correcting defects in a digital image in which the system and method do not require additional components and the method also adjusts the pixels surrounding the defective pixels.

It is also an object of this invention to provide a user of the system and method of this invention with the ability to select, add, or verify defect areas.

To achieve these and other objects, one aspect of the invention includes a method for correcting defects in a input digital image, where the method comprises the steps of identifying the defects to form at least one defect map, generating a region of interest for each defect map, correcting the values of the pixels in each defect map, and adjusting the values of the pixels in each region of interest.

In another aspect of this invention, the step of identifying the defects further comprises the steps of filtering the input digital image with a median filter to generate a filtered image, generating a difference image by subtracting the filtered image from the input digital image, and identifying as defects the pixels at which the difference image pixel value exceeds a given threshold.

In yet another aspect of this invention, the step of correcting the values of the pixels in each defect map further comprises the steps of filtering the input digital image with a median filter to generate a filtered image and replacing the pixel values in each defect map with the corresponding filtered image pixel values.

In a further aspect of this invention, the step of adjusting the values of the pixels in each region of interest further comprises the steps of filtering the input digital image with a median filter to generate a filtered image, replacing the pixel values in each defect map with the corresponding filtered image pixel values, and performing a smoothing operation to obtain the adjusted value of the pixels in each region of interest corresponding to each defect map.

In still another aspect of this invention, the interpolation of the value at each pixel in each defect map and/or the smoothing operation to obtain the adjusted value of the pixels in each region of interest include utilizing coring means.

In yet other aspects of this invention, the step of identifying the defects also includes utilizing user provided information. A user can define, prior to identifying the defects, selected areas, where the defects are identified. Similarly, the user can define, prior to identifying the defects, selected areas, where the identification of defects is precluded. A user can also identify at least one of many points as defects.

In a further aspect of this invention, prior to generating a region of interest for each defect map, the identified defect maps are displayed superimposed on the input digital image, forming a defect map display image. The user can select an area of observation from the defect map display image, and, upon receipt of a display command from a user, display a section of the input digital image located under the defect map display image in the area of area of observation.

Other aspects of this invention are the computer program product comprising a computer readable medium having computer readable code that causes a computer system to perform the above described methods, a digital image processing system utilizing the above described methods, and a digital image acquisition system that utilizes the above described methods to identify and correct defects.

The methods of this invention do not require additional components in the digital image acquisition system and can be implemented in any existing digital image acquisition system. Yet, the methods of this invention are computationally simple and can be applied in real time defect identification and correction. The utilization of coring means provides for the removal of noise as well as defects thereby providing superior image enhancement quality. Adjusting the pixels surrounding the defective pixels reduces the generation of artifacts in the corrected image.

Including user provided information can prevent false detection of defects and can complement the detection of defects obtained by analyzing the image. Combining the aspects of this invention in which identification of defects comprises operating on the image (such as filtering the image) with the use of user provided information for defect identification yields a defect identification method that is at least as accurate, and potentially more accurate, than methods requiring additional hardware components.

The methods of this invention can be applied to an input digital image provided by any device capable of providing a digital image. For example, the digital input image can be obtained from a scanner, a digital camera or any computer readable medium. Since the user can select points or areas of the input image to be corrected, defects can include any feature of the image to be corrected or modified. For example, the methods of this invention can be applied to remove wires and other unwanted elements from frames in digital versions of motion pictures. In this example, the methods of this invention can used to produce special effects in motion pictures.

### DESCRIPTION OF THE DRAWINGS

The novel features that are considered characteristic of the invention are set forth with particularity in the appended claims. The invention itself, however, both as to its organization and its method of operation, together with other objects and advantages thereof will be best understood from the following description of the illustrated embodiment when read in connection with the accompanying drawings wherein:

FIG. 1 depicts an embodiment of an image acquisition system including an image processing system constructed according to this invention;

FIG. 1A depicts a block diagram of selected components of an embodiment of a processing module containing an image processing system constructed according to this invention;

FIG. 2 depicts a flowchart of an embodiment of a method, according to this invention, for identifying and correcting defects in an input digital image;

FIG. 3 depicts a flowchart of an embodiment of a method, according to this invention, for identifying defects in an input digital image;

FIG. 4 is a graphical representation of a defect map and a region of interest;

FIG. 5 is a graphical representation of a defect map and a region of interest at the pixel level;

FIG. 6 depicts a flowchart of an embodiment of a method, according to this invention, for correcting the values of the pixels in each defect map;

FIG. 7 depicts a flowchart of an embodiment of a method, according to this invention, for generating a region of interest;

FIG. 8 depicts a flowchart of an embodiment of a method, according to this invention, for adjusting the values of the pixels in each region of interest;

FIG. 9A is a graphical representation of a pixel under consideration for defect identification and a neighborhood of pixels around the pixel under consideration;

FIG. 9B is a graphical representation of a distribution of pixel values in a partition image and depicts an embodiment of a threshold obtained from characteristics of the partition image pixel values;

FIG. 10 is a graphical representation of an embodiment of means for a user to identify or preclude the correction of defects, or add or delete defects;

FIG. 11 is a graphical representation of a digital image and a selected area in that image;

FIG. 12 is a graphical representation of an embodiment of a defect map display image;

FIG. 13 is a graphical representation of an embodiment of a defect map display image illustrating the selection of an area of observation.

### DETAILED DESCRIPTION

The present invention discloses a system and method for identifying and correcting defects in an input digital image in which the method does not to require additional hardware components in the digital image acquisition system and reduces the generation of artifacts in the corrected image. The system and method of this invention, described below, takes into account the uncertainty of defect identification by identifying the defects to form at least one defect map and, then, generating a probable defect area surrounding the entire perimeter of the defect map (region of interest). The values of the pixels are corrected in both the defect map and the region of interest. The effect of uncertainty in defect identification is also mitigated by utilizing user provided information.

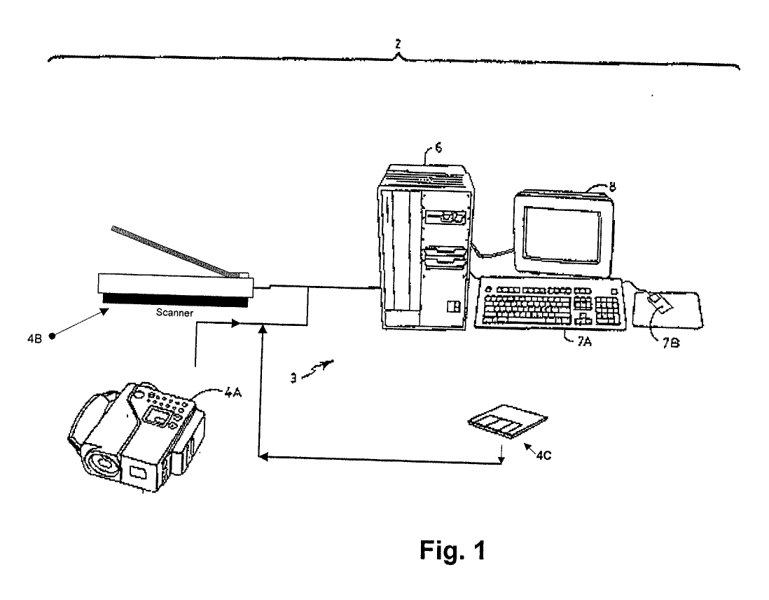

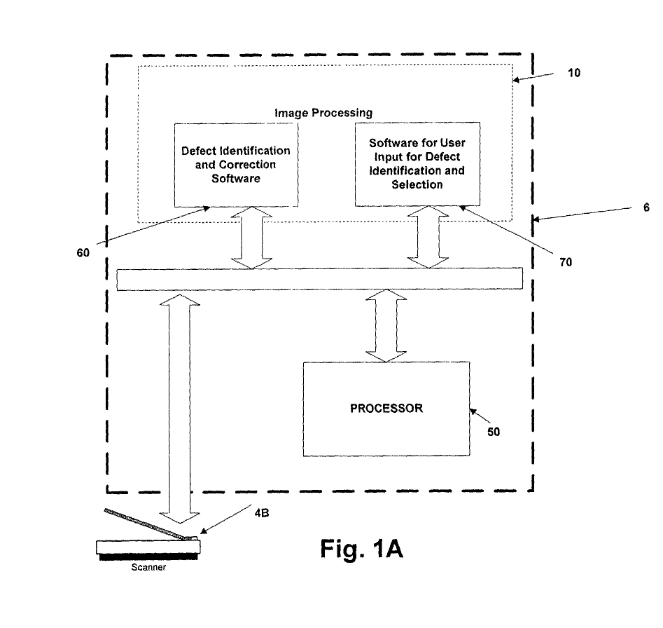

FIG. 1 depicts an embodiment of an image acquisition system 2 including an image processing system 10 (shown in FIG. 1A) constructed according to this invention. Referring to FIG. 1, the image acquisition system 2, in one embodiment, includes a computer system 3, and means for acquiring a digital image such as acquisition devices 4A and 4B (digital camera 4A and scanner 4B) and computer readable media 4C. The computer system 3, in the embodiment shown in FIG. 1, includes a processing module 6, input components such as a keyboard 7A and/or a mouse 7B and output components such as a video display device 8. A block diagram of selected components of an embodiment of a processing module containing an image processing system 10 constructed according to this invention is shown in FIG. 1A. Referring to FIG. 1A, the processor 50 reads the software (computer readable code) 60 and 70 which causes the processor 50 to perform the methods of this invention. The computer readable code 60 and 70 is embodied in computer readable media (not shown). In the embodiment shown in FIG. 1A, the image processing system 10 is comprised of Defect Identification and Correction Software 60, which provides means for identifying the defects and means for defect correction, and Software for User Input for Defect Identification and Selection 70. Computer readable media (not shown) such as memory and mass storage devices, such as disk and/or tape storage elements (not separately shown), are typically included in processing module 6.

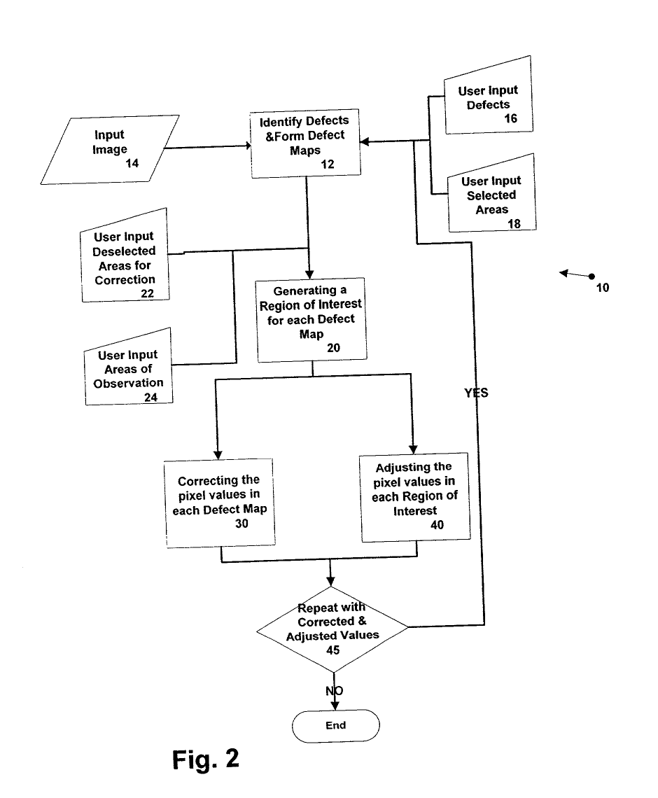

A flowchart of an embodiment of a method, according to this invention, for identifying and correcting defects in an input digital image 14 is shown in FIG. 2. Referring to FIG. 2, the input digital image 14, comprised of a multiplicity of pixels, each pixel having at least one given value selected from at least one of many image description parameters, provides the initial data for the method. For example, the image could be represented by R, G, B values or Y, u, v values or any other color space representation or could be a monochrome image. From the input image 14, the defects are identified (step 12, FIG. 2), forming at least one defect map. The defect maps are comprised of adjoining defect pixels, defect pixels being input digital image pixels. In a tri-color image, the defect identification can be applied to all three colors or to the luminance (Y) component only.

As described in commonly-owned and concurrently filed U.S. patent application Ser. aa/AAA, AAA entitled “Method and System for User Assisted Defect Removal” (Attorney Case No. 8519), which is hereby incorporated by reference in its entirety, user input can mitigate the effects of uncertainty in defect identification. User input can define, prior to step 12, at least one area of the acquired digital image as a selected area 18, wherein the identifying of the defects to form at least one defect map is restricted to or precluded from the selected area. The input digital image 14 can be entire acquired digital image, or the at least one selected area 18 (if the identifying is restricted to the selected area), or the acquired digital image except the selected areas 18 (if the identifying is precluded from the selected area). User input can also define at least one point as a defect 16, at least one point defining a user input defect pixel.

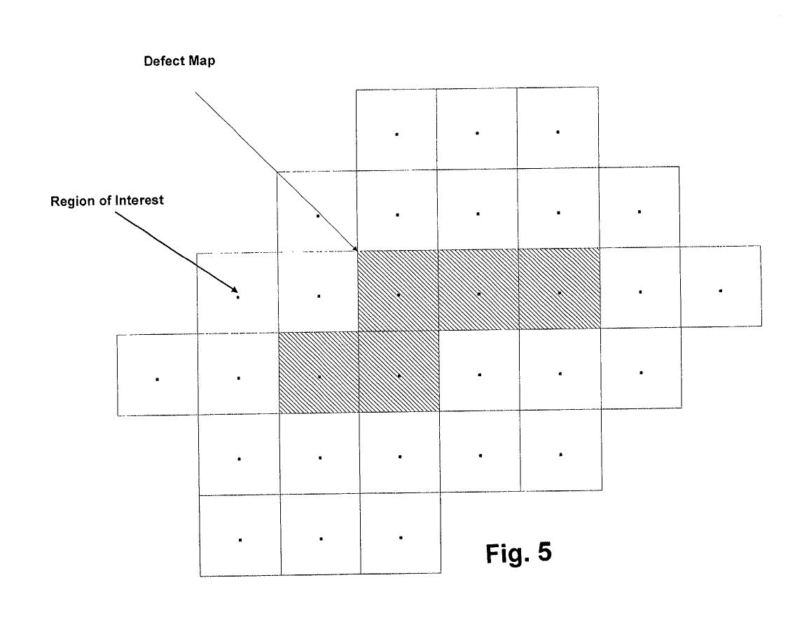

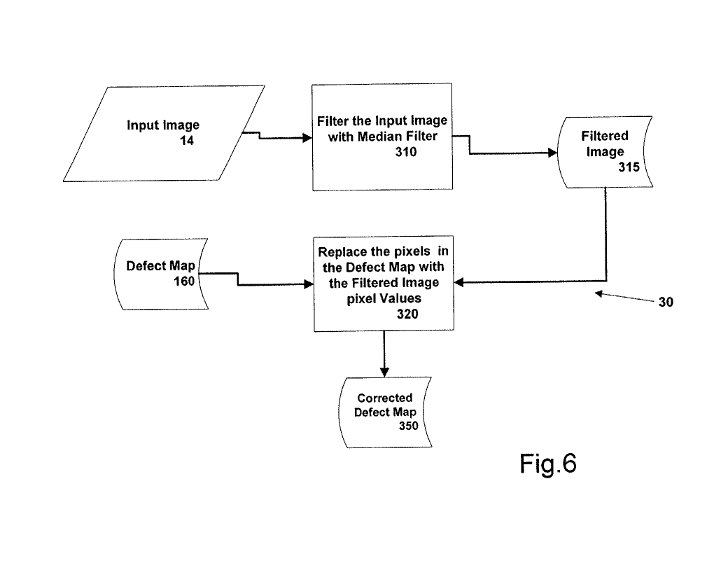

After forming the defect maps, a region of interest is generated for each defect map (step 20, FIG. 2). The region of interest surrounds the entire perimeter of the corresponding defect map, as shown in FIGS. 5 and 6. The region of interest can, in one embodiment, be defined a priori as having a width of several pixels (2 or 3 pixels wide) or, in another embodiment, can be obtained by means of a dilation operation, as detailed below. Each region of interest is comprised of a select number of pixels from the input digital image pixels. User input can define, prior to step 20 (FIG. 2), at least one area of the input digital image as a deselected area for correction 22, where the generating of a region of interest (step 20, FIG. 2) and subsequent steps are precluded in the deselected areas.

The values of the pixels in each defect map are corrected by applying correction means (step 30, FIG. 2). One embodiment of the method for correcting the values in each defect map is detailed below. Other methods for correcting the values in each defect map include interpolating from the pixels in the surrounding region, replacing the values in each defect map with the mean or median value obtained using a surrounding region.

The values of the pixels in each region of interest are adjusted by applying adjusting means (step 40, FIG. 2). Means for adjusting the values of the pixels in each region of interest include smoothing operations such as fitting to a model, filtering (interpolation and averaging being forms of filtering) or a combination of fitting and filtering (see for example, W. H. Press et al., Numerical Recipes, 1^{st} edition, pp. 495-497 and references therein, ISBN 0-521-30811-9, Cambridge University Press, 1986).

The method of FIG. 2 can be repeated, from step 12 to steps 30 and 40, using an input digital image incorporating the corrected and adjusted pixel values (step 45, FIG. 2) and utilizing different parameters, as described below, in the step of identifying the defects.

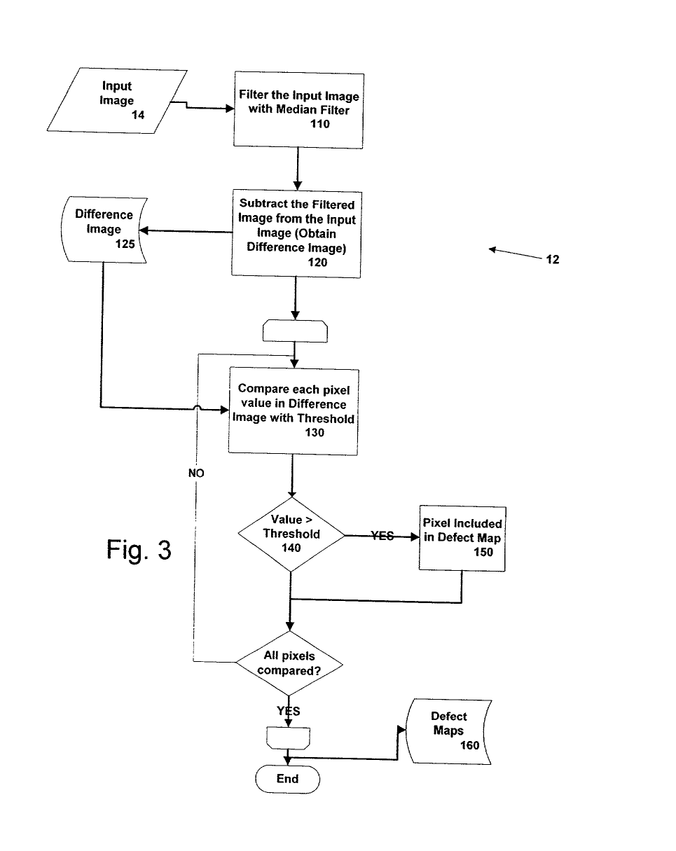

FIG. 3 depicts a flowchart of an embodiment of a method, according to this invention, for identifying defects in an input digital image. Referring to FIG. 3, the input digital image 14 is filtered with a Median Filter (step 110, FIG. 3). The output of a one-dimensional Median Filter of extent nᵥ (where is nᵥ is an odd number) at location n is the median of the sequence from n−(nᵥ−1)/2 to n+(nᵥ−1)/2. The Median Filter could be a two dimensional Median Filter of extent nᵥ , n_{H} or the product of two one dimensional Median Filters, one in the horizontal direction of extent n_{H} and one in the vertical direction of extent nᵥ. The parameters nᵥ, n_{H} are preset, or determined by the user or can depend on the defect map. (Median Filters are described in Digital Image Processing, by William K. Pratt, John Wiley and Sons, 1978, ISBN 0-471-01888-0, pp. 320-322). The result of median filtering the input digital image 14 is a filtered image. The filtered image is subtracted from the input digital image 14 (step 120, FIG. 3) to obtain a difference image 125. On a pixel by pixel basis, each pixel value of the difference image is compared to a threshold (step 130, FIG. 3). The threshold can be preset, or determined by the user, or can depend on local properties of the input digital image 14. (For example, the threshold can depend on the properties of the difference image.) If the pixel value is greater than threshold (step 140, FIG. 3), the pixel is included in a defect map (step 150, FIG. 3). Once all the pixels have been compared, the result is at least one defect map 160. (In one implementation, the defect map is a binary map. When the pixel is identified as a defect, that location is included in the binary map as a defect location. In the process of correcting the defects, the pixels at those locations identified as defect locations are defect pixels and are corrected. In the implementation in which the defect map is a binary map, the “pixel values in each defect map” refers to the pixel values for pixels at those locations identified as defect locations. Similarly, in this implementation, “a defect map composed of defect pixel” refers to the combination of a binary defect map and the pixels at those locations identified as defect location for that defect map. It should be apparent that this implementation is equivalent to the defect map/defect pixel grouping described herein. The term defect map as used herein encompasses both implementations).

A flowchart of an embodiment of the method to correct the pixels in a defect map is shown in FIG. 6. The input image or a selected area of the input image 300 is filtered with a Median Filter (step 310, FIG. 6) to produce a filtered image 315. The pixels in the defect map 160 are replaced with the filtered image pixel values (step 320, FIG. 6) to produce a corrected defect map 350. In another embodiment (not shown) a defect map with replacements is generated by replacing the pixels in the defect map with the filtered image pixel values. For each pixel in the defect map with replacements, a value is interpolated from the surrounding pixels, that value becoming the pixel value for the corrected defect map 350.

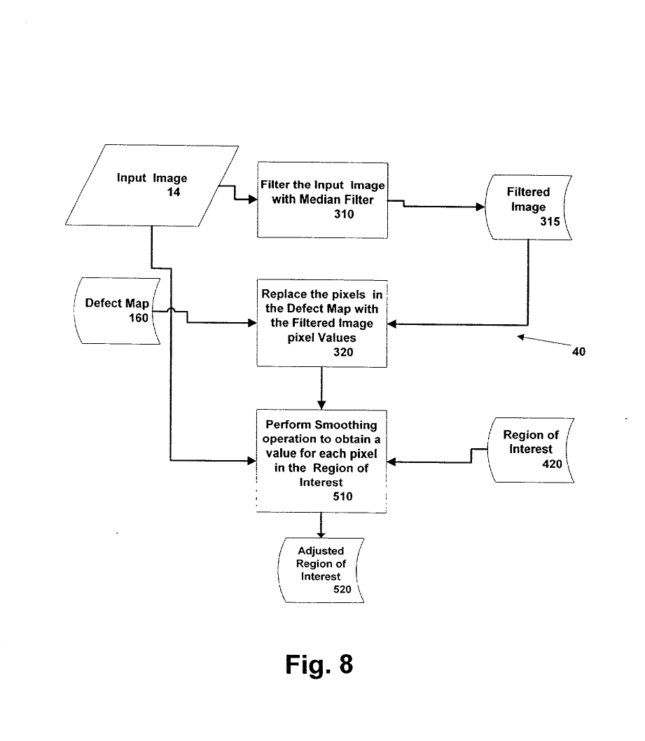

In order to take into account the uncertainty of defect identification, besides correcting the defects in each one of many defect maps, the pixel values of the pixels in each region of interest corresponding to each defect map are adjusted. A flowchart of an embodiment of the method to adjust the pixels in a region of interest is shown in FIG. 8. The input image 14 is filtered with a Median Filter (step 310, FIG. 8) to produce a filtered image 315. The pixels in the defect map 160 are replaced with the filtered image pixel values (step 320, FIG. 8) to produce a corrected defect map 350. These steps are the same as in method described by the flowchart of FIG. 6 and can be performed once for both methods. For each region of interest 420 corresponding to a defect map 160, smoothing operations (such as fitting to a model, filtering, interpolation and averaging being forms of filtering, or a combination of fitting and filtering) are performed to obtain a value for each pixel in the region of interest 420, that value becoming the pixel value for the adjusted region of interest 520.

Details of one embodiment of this invention are given below.

### Sample Embodiment

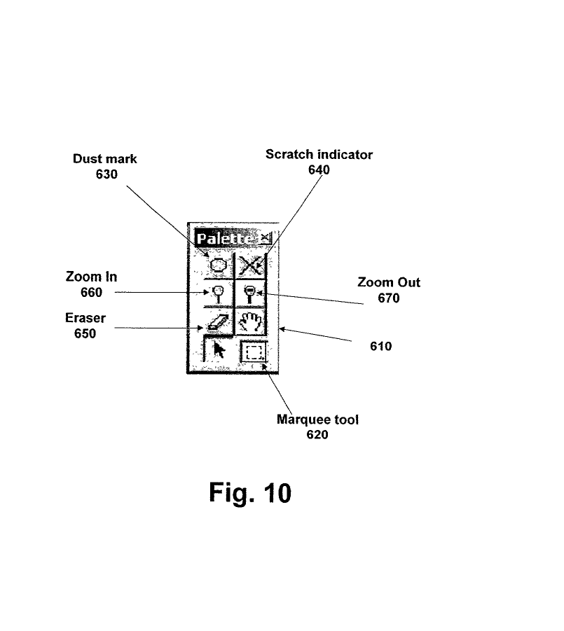

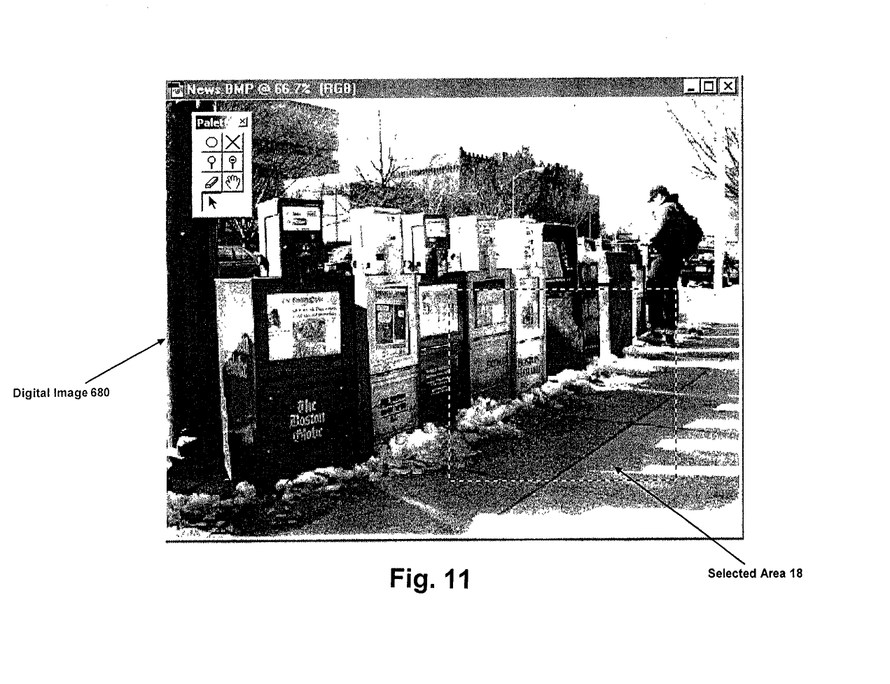

In a specific embodiment, a digital image 680 (for example, that shown in FIG. 11) is acquired via an acquisition device, such as scanner 4B or digital camera 4A, or from a computer readable medium 4C. The digital image 680 is displayed in the video display device 8. The display image comprises a palette 610 (shown in FIG. 10), which constitutes means for a user to identify or preclude the correction of defects, or add or delete defects. Using the keyboard 7A and/or the mouse 7B, a marquee tool 620 is selected from the palette 610 and is used to define at least one area of the digital image 680 as a selected area 18, where, in the identifying of the defects to form at least one defect map, the identifying is restricted to or precluded from the selected areas. A menu of commands (not shown), such as a pop-up menu, appears when the user gives a designated input (for example, when the user “clicks” on the selected area 18 with the mouse 7B or gives a designated keyboard 7A input). The command menu includes commands for identifying the defects (Identify defects, for example), and precluding the identification of defects (Do not identify, for example). The input digital image 14 can be entire input image 680, or the at least one selected area 18 (if the identifying is restricted to the selected area), or input image 680 except the selected areas 18 (if the identifying is precluded from the selected area).

Referring to FIG. 3, the input digital image 14 is filtered with a two dimensional Median Filter (step 110, FIG. 3) of extent nᵥ, n_{H}. The parameters nᵥ, n_{H} are determined by the user and can depend on a priori estimates of the defect map. For example, if, from the input digital image 14, it is apparent that that the defects are clustered in groups of width smaller than or equal to 2 pixels, nᵥ and n_{H} can be 5 or 7 pixels each. However, if it is apparent that that the defects are clustered in groups of width of approximately 6 pixels, nᵥ and n_{H} can be 21 or 23 pixels each. The result of median filtering the input image 14 is a filtered image. The filtered image is subtracted from the input image 14 (step 120, FIG. 3) to obtain a difference image. On a pixel by pixel basis, each pixel value of the difference image is compared to a threshold (step 130, FIG. 3). The threshold depends on local properties of the difference image. If the difference image pixel value is greater than threshold (step 140, FIG. 3), the pixel is included in a defect map (step 150, FIG. 3). Once all the pixels have been compared, the result is at least one defect map 160 for the input digital image 14.

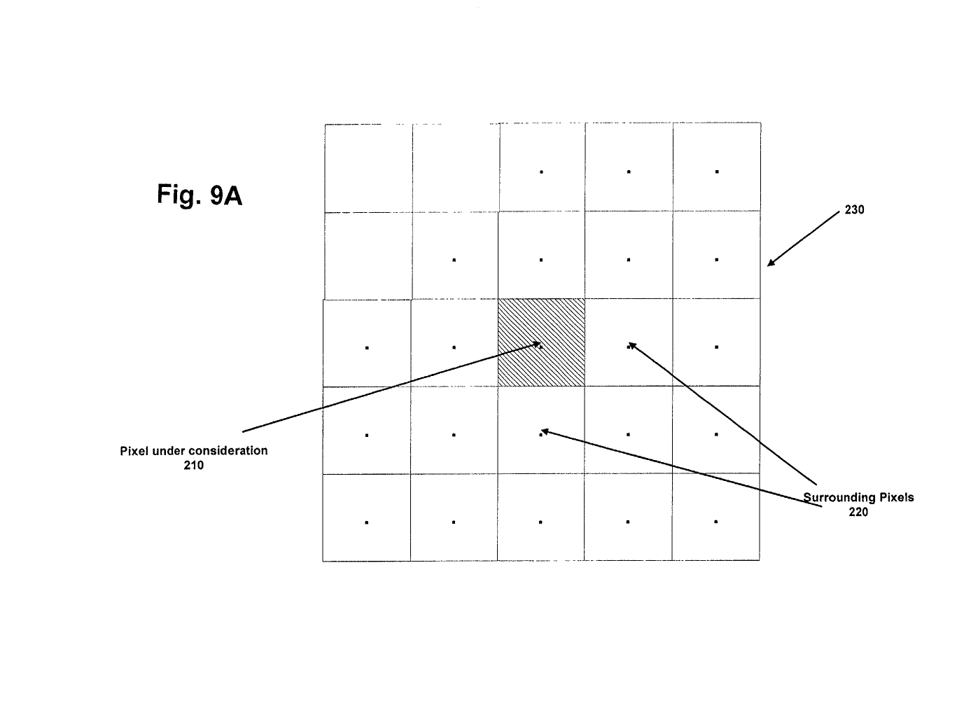

The threshold for each pixel can be obtained from the properties of surrounding pixel values (see FIG. 9A) in a neighborhood 230 of a pixel under consideration 210. An embodiment of a method for obtaining a threshold from local characteristics of image pixel values in a neighborhood 230 of the pixel under consideration 210 can be understood from FIGS. 9A, 9B. Referring to FIG. 9A, the neighborhood 230 of a pixel under consideration 210 (the pixel at which the threshold is needed) comprises a number of pixels surrounding the pixel under consideration 210. A Gaussian approximation, as shown in FIG. 9B, can be obtained for a histogram of the number of neighborhood pixels at a particular difference image pixel value range. The Gaussian approximation has the same mean value and standard deviation as the difference image pixels in the neighborhood 230 of the pixel under consideration 210. The threshold value 550 is defined as the pixel value at which the area under the Gaussian from that value to +∞ is a given amount. (In the case shown in FIG. 9B, the threshold value 550 is the pixel value at which the area under the Gaussian from that value to +∞ is 0.1.)

The mean and standard deviation can also be calculated for the input image 14 pixel values for the pixels in the neighborhood 230 of the pixel under consideration 210. If the standard deviation of the values of the input image pixels in the neighborhood 230 of the pixel under consideration 210 exceeds a predetermined amount, indicating a very active neighborhood, no defects are identified. (This is tantamount to selecting a threshold that is arbitrarily large.) Thus, a separate threshold 550 is provided for each pixel and the threshold 550 for each pixel is obtained from the local characteristics of the pixel values of the input image 14. (The local difference image pixel values are also the local characteristics of the pixel values of the input image 14.)

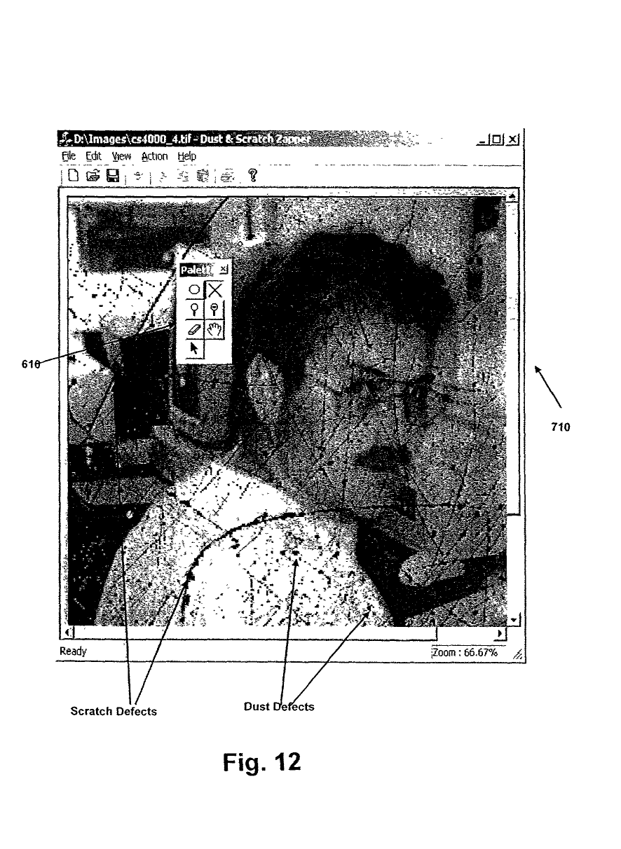

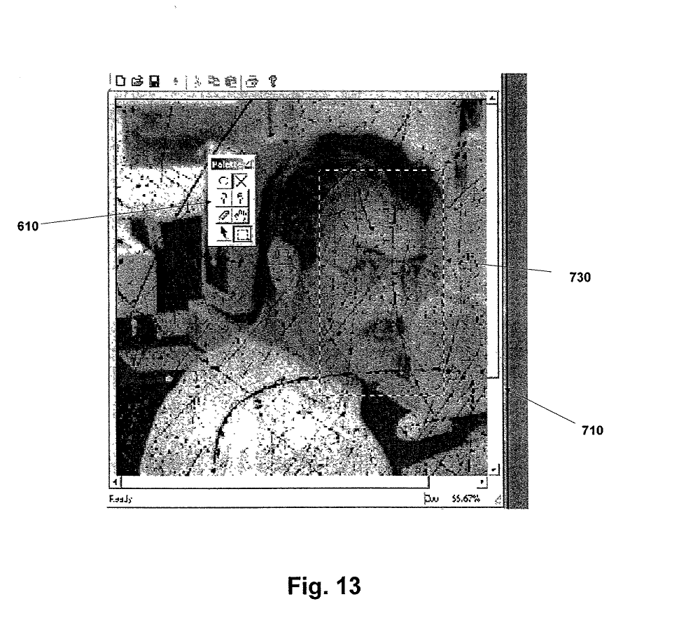

Once all the defect maps have been identified, the identified defect maps are superimposed on the input digital image, forming a defect map display image 710 (shown in FIG. 12). Using the dust mark tool 630 in the palette 610 for point defects or the scratch indicator tool 640 in the palette 610 for a number of defects, the user can identify at least one point as an additional defect. Using the eraser tool 650 in the palette 610, the user can select at least one of many defect points from the defect map display image, these selected points being precluded from the correction of defects. These selected points are removed from the corresponding defect map.

Using the marquee tool, the user can select an area of the defect map display image as an area of observation 24. Upon issuing a display command (from the pop-up menu, for example), the user can display a section of the input digital image located under the defect map display image in the area of observation.

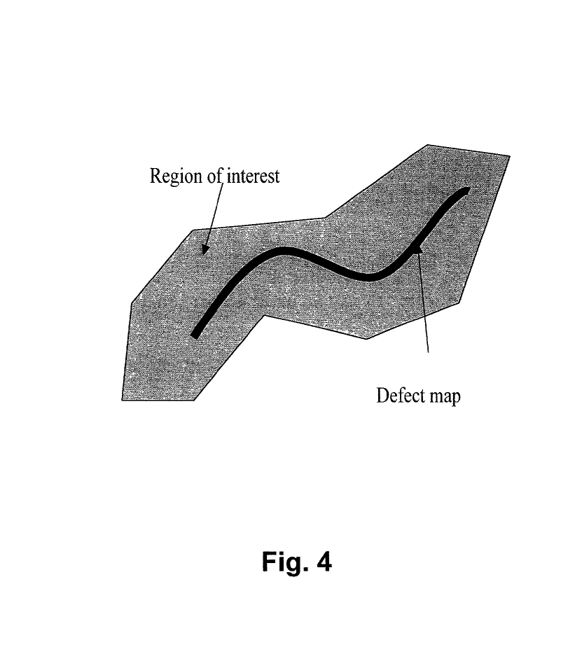

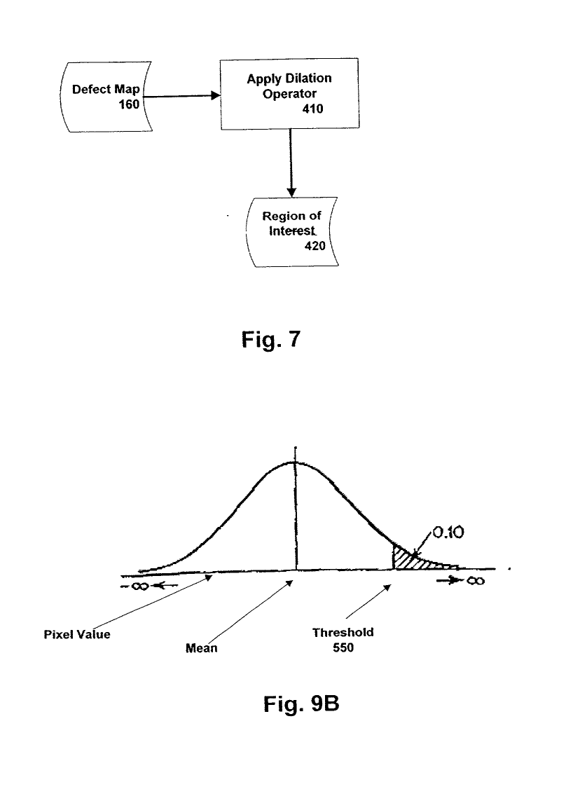

After forming the defect maps, a region of interest is generated for each defect map (step 20, FIG. 2). The region of interest surrounds the entire perimeter of the corresponding defect map, as shown in FIGS. 4 and 5. FIG. 7 depicts a flowchart of an embodiment of a method, according to this invention, for generating a region of interest. A dilation operation is performed on a defect map 160 (step 410, FIG. 7). The result of this operation is the region of interest 420 corresponding to the defect map 160. (Dilation operations are described in “An Introduction to Morphological Image Processing”, By E. R. Dougherty, SPIE Optical Engineering Press, 1992, ISBN 0-8194-0845-X, pp7-10, 33-42, 98-103). The region of interest is typically 2 to 3 pixels wide.

In correcting the defects, the values of the pixels in each defect map 160 are replaced with the filtered image pixel values of the filtered image 315 (step 320, FIG. 6) to produce a corrected defect map 350.

For each region of interest 420 corresponding to a defect map 160, a least the pixel values in a neighborhood around each pixel in the region of interest 520 (incorporating the corrected values) are filtered, and coring means are applied, to yield a value for each pixel in the region of interest 420, that value becoming the pixel value for the adjusted region of interest 520. In one embodiment, an average pixel value (averaging being a filtering operation) is obtained utilizing the pixel values in a neighborhood around each pixel in the region of interest 520 and the pixel under consideration (in the region of interest 520) to obtain the adjusted pixel value for the adjusted region of interest 520. (Coring means can also be applied when interpolation is used to yield the corrected defect map 350. Coring is described in U.S. Pat. No. 4,523,230, “System for Coring an Image-representing Signal”, C. R. Carlson et al., issued on Jul. 11, 1985, and “Noise Removal via Bayesian Wavelet Coring”, Proceedings 3^{rd} IEEE International Conference on Image Processing at Lausanne, Switzerland by Eero P. Simonelli and Edward H. Adelson, and references therein.)

For an updated input image incorporating the corrected and adjusted pixel values, the methods of FIG. 2 and FIGS. 6, and 8 can be repeated. A threshold value is calculated for each pixel of the difference image derived from the image obtained by incorporating the corrected and adjusted pixel values into the input image 14. A different criterion is used to determine the threshold (for example, the pixel value at which the area under the Gaussian from that value to +∞ is 0.05 instead of 0.1). Thus, second pass of correction and adjustment is obtained.

A computer readable code implementing the above described method for correcting defects in a input digital image, embodied in a computer readable medium, constitutes one embodiment of a digital image processing system for correcting defects in the input digital image. The computer readable code provides the means to implement the method.

While the above described method for correcting defects applies to interior pixels of the digital image, it should be apparent that one of several prescriptions can be applied to extend the method to boundary points. The computer readable code implementing the above described method implements an appropriate one of the prescriptions for the incorporation of boundary points.

It should be appreciated that the various embodiments described above are provided merely for purposes of example and do not constitute limitations of the present invention. Rather, various other embodiments are also within the scope of the claims, such as the following. The values in each defect map can be corrected by interpolating from the pixels in the surrounding region or by replacing the values in each defect map with the mean or median value obtained using a surrounding region. The values of the pixels in each region of interest can be adjusted by filtering (interpolation and averaging being forms of filtering) or a combination of fitting and filtering (see for example, W. H. Press et al., Numerical Recipes, ₁st edition, pp. 495-497 and references therein, ISBN 0-521-30811-9, Cambridge University Press, 1986). Partition images can be used or the image can be corrected as one image. The system of FIGS. 1 and 1A can be implemented with more than one processor, with a dedicated processor for some of the tasks and another processor for the remainder of the tasks or any combination thereof.

In general, the techniques described above may be implemented, for example, in hardware, software, firmware, or any combination thereof. The techniques described above may be implemented in one or more computer programs executing on a programmable computer including a processor (or more than one processor), a storage medium readable by the processor (including, for example, volatile and non-volatile memory and/or storage elements), at least one input device, an acquisition device or means to accept an input image and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program within the scope of the claims below may be implemented in any programming language, such as assembly language, machine language, a high-level procedural programming language, or an object-oriented programming language. The programming language may be a compiled or interpreted programming language. Each computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output.

The acquisition of the input digital image can occur at a location remote from the processor and rendering display. The operations performed in software utilize instructions (“code”) that are stored in computer-readable media and store results and intermediate steps in computer-readable media. The input digital image may also be acquired from a computer readable medium.

Common forms of computer-readable media include, for example, a floppy disk, a flexible disk, hard disk, magnetic tape, or any other magnetic medium, a CDROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read. Electrical, electromagnetic or optical signals that carry digital data streams representing various types of information are exemplary forms of carrier waves transporting the information.

Other embodiments of the invention, including combinations, additions, variations and other modifications of the disclosed embodiments will be obvious to those skilled in the art and are within the scope of the following claims.

What is claimed is:

1. A method for correcting defects in a input digital image, said input digital image comprised of a plurality of pixels, each pixel having at least one given value selected from at least one of a plurality of image description parameters, said method comprising the steps of:
(A) identifying the defective pixels from the input digital image to form at least one defect map, said defect map comprised of at least one defect pixel;
(B) generating a region of interest for each defect map, each said region of interest surrounding the entire perimeter of said corresponding defect map, and comprising a plurality of region of interest pixels from said input digital image pixels;
(C) correcting the values of the defect pixels in each defect map;
(D) adjusting the values of the region of interest pixels in each region of interest.

2. The method of claim 1 wherein the step of identifying the defects further comprises the steps of:
filtering the input digital image with a median filter to generate a filtered image, said filtered image comprised of a plurality of filtered image pixels, each filtered image pixel having at least one value selected from at least one of a plurality of image description parameters; and
generating a difference image by subtracting the filtered image from the input digital image, said difference image comprised of a plurality of difference image pixels, each difference image pixel having at least one value selected from at least one of a plurality of image description parameters; and
identifying as defects the pixels at which the difference image pixel value exceeds a given threshold.

3. The method of claim 2 wherein said threshold is obtained from local characteristics of said input image pixel values.

4. The method of claim 1 wherein the step of correcting the values of the pixels in each defect map further comprises the steps of:
filtering the input digital image with a median filter to generate a filtered image, said filtered image comprised of a multiplicity of filtered image pixels, each filtered image pixel having at least one value selected from at least one of a plurality of image description parameters;
replacing the pixel values in each defect map with the corresponding filtered image pixel values.

5. The method of claim 4 further comprising the step of:
interpolating the value at each pixel in each defect map from neighboring pixel values, said neighboring pixels being located in said defect map, or from the region of interest corresponding to said defect map, or the input digital image.

6. The method of claim 5 wherein the step of interpolating the value at each pixel in each defect map includes utilizing coring means.

7. The method of claim 1 wherein the step of adjusting the values of the pixels in each region of interest further comprises the steps of:
filtering the input digital image with a median filter to generate a filtered image, said filtered image comprised of a plurality of filtered image pixels, each pixel having at least one given value selected from at least one of a plurality of image description parameters; and
replacing the pixel values in each defect map with the corresponding filtered image pixel values;
performing a smoothing operation to obtain the adjusted value of the pixels in each region of interest corresponding to each defect map, said smoothing operation being performed on the pixel values of said region of interest and on the pixel values of neighboring pixels, said neighboring pixels being located in said defect map, said region of interest, or the input digital image.

8. The method of claim 7 wherein the step of performing a smoothing operation to obtain the adjusted value of the pixels in each region of interest includes utilizing coring means.

9. The method of claim 1 wherein the region of interest for each defect map is generated by means of a dilation operation on said defect map.

10. The method of claim 2 further comprising the step of:
repeating steps (A) through (D), after step (D), utilizing the corrected and adjusted pixel values as input digital image values and utilizing a second iteration threshold.

11. The method of claim 1 further comprising the step of:
defining, prior to step (B), at least one area of the input digital image as a selected area;
and, wherein the generating of a region of interest is precluded in said selected areas, the correcting of the values of the pixels in each defect map, and the adjusting of the values of the pixels in each region of interest are precluded in said selected areas.

12. The method of claim 1 wherein the step of identifying the defects further comprises the step of:
identifying at least one point as a defect, said point defining a defect pixel, said identification being performed by a user.

13. The method of claim 2 further comprising the step of:
identifying at least one point as an additional defect, said points defining the defect pixels, said identification being performed by a user.

14. The method of claim 1 further comprising the step of:
displaying, prior to step (B), the identified defect maps superimposed on the input digital image, forming a defect map display image.

15. The method of claim 14 further comprising the steps of:
selecting, prior to step (B), an area of the defect map display image, said selected area being an area of observation;
displaying, upon receipt of a display command from a user, a section of the input digital image located under the defect map display image in said area of area of observation.

16. The method of claim 14 further comprising the step of:
selecting, prior to step (C), at least one defect point from the defect map display image, said selected points being precluded from step (C).

17. The method of claim 16 further comprising the steps of:
removing said selected points from the corresponding defect map.

18. A digital image processing system for correcting defects in a input digital image, said input digital image comprised of a multiplicity of pixels, each pixel having given values of at least one of a plurality of image description parameters, said system comprising:
means for identifying the defective pixels from the input digital image to form at least one defect map, said defect map comprised of at least one defect pixel;
means for generating a region of interest for each defect map, each said region of interest surrounding the entire perimeter of said corresponding defect map, and comprising a plurality of region of interest pixels from said input digital image pixels;
means for correcting the values of the pixels in each defect map;
means for adjusting the values of the pixels in each region of interest.

19. The system of claim 18 wherein the means for identifying the defects further comprise:
means for filtering the input digital image with a median filter to generate a filtered image, said filtered image comprised of a plurality of filtered image pixels, each filtered image pixel having at least onevalue selected from at least one of a plurality of image description parameters;
means for generating a difference image by subtracting the filtered image from the input digital image, said difference image comprised of a plurality of difference image pixels, each difference image pixel having at least one given value selected from at least one of a plurality of image description parameters; and
means for identifying as defects the pixels at which the difference image pixel value exceeds a given threshold.

20. The system of claim 19 wherein said threshold is obtained from local characteristics of said image pixel values.

21. The system of claim 18 where the means for correcting the values of the pixels in each defect map further comprise:
means for filtering the input digital image with a median filter to generate a filtered image, said filtered image comprised of a multiplicity of filtered image pixels, each pixel having at least one given value selected from at least one of a plurality of image description parameters; and
means for replacing the pixel values in each defect map with the corresponding filtered image pixel values.

22. The system of claim 21 further comprising:
means for interpolating the value at each pixel in each defect map from neighboring pixel values, said neighboring pixels being located in said defect map, the region of interest corresponding to said defect map, or the input digital image.

23. The system of claim 22 where the means for interpolating the value at each pixel in each defect map further comprise coring means.

24. The system of claim 18 where the means for adjusting the values of the pixels in each region of interest further comprise:
means for filtering the input digital image with a median filter to generate a filtered image, said filtered image comprised of a plurality of filtered image pixels, each pixel having at least one given value selected from at least one of a plurality of image description parameters; and
means for replacing the pixel values in each defect map with the corresponding filtered image pixel values; and
means for performing a smoothing operation to obtain the adjusted value of the pixels in each region of interest corresponding to each defect map, said smoothing operation being performed on the pixel values of said region of interest and on the pixel values of neighboring pixels, said neighboring pixels being located in said defect map, said region of interest, or the input digital image.

25. The system of claim 24 where the means for performing a smoothing operation to obtain the adjusted value of the pixels in each region of interest further comprise coring means.

26. The system of claim 18 where the means for generating a region of interest for each defect map further comprise means for performing a dilation operation on said defect map.

27. The system of claim 18 further comprising:
means for defining at least one area of the input digital image as a selected area, where the utilization of said means for generating of a region of interest is precluded in said selected areas, for correcting of the values of the pixels in each defect map, and for adjusting of the values of the pixels in each region of interest are precluded from said selected areas.

28. The system of claim 18 where the means for identifying the defects further comprise:
means for identifying at least one point as a defect, said points defining the defect pixels, said identification being performed by a user.

29. The system of claim 19 further comprising:
means for identifying at least one point as an additional defect, said points defining the defect pixels, said identification being performed by a user.

30. The system of claim 18 further comprising:
means for displaying the identified defect maps superimposed on the input digital image, forming a defect map display image.

31. The system of claim 30 further comprising:
means for selecting an area of the defect map display image, said selected area being an area of observation; and
means for displaying, upon receipt of a display command from a user,
a section of the input section of the input digital image located under the defect map display image in said area of area of observation.

32. The system of claim 30 further comprising:
means for selecting, prior to correcting the values of the pixels in each defect map, at least one defect point from the defect map display image, said selected points being precluded from being corrected.

33. The system of claim 32 further comprising:
means for removing said selected points from each corresponding defect map.

34. A digital image acquisition system comprising:
means for acquiring an input digital image, said image comprised of a plurality of pixels, each pixel having given values of at least one of a plurality of image description parameters; and
at least one digital processor;
a computer readable medium having computer readable code embodied therein for correcting defects in said input digital image, said code causing said at least one digital processor to:
identify the defective pixels from the input digital image to form at least one defect map, said defect map comprised of at least one defect pixel; and
generate a region of interest for each defect map, each said region of interest surrounding the entire perimeter of said corresponding defect map, and comprising a plurality of region of interest pixels from said input digital image pixels; and
correct the values of the pixels in each defect map; and
adjust the values of the pixels in each region of interest.

35. The digital image acquisition system of claim 34 where, the computer readable code that causes the at least one digital processor to identify the defects to form at least one of a plurality of defect maps further causes the at least one digital processor to:
filter the input digital image with a median filter to generate a filtered image, said filtered image comprised of a plurality of filtered image pixels, each filtered image pixel having at least one given value selected from at least one of a plurality of image description parameters; and
generate a difference image by subtracting the filtered image from the input digital image, said difference image comprised of a plurality of difference image pixels, each difference image pixel having at least one given value selected from at least one of a plurality of image description parameters; and
identify as defects the pixels at which the difference image pixel value exceeds a given threshold.

36. The digital image acquisition system of claim 34 where, the computer readable code that causes the at least one digital processor to correct the values of the pixels in each defect map further causes the at least one digital processor to:
filter the input digital image with a median filter to generate a filtered image, said filtered image comprised of a multiplicity of filtered image pixels, each pixel having at least one given value selected from at least one of a plurality of image description parameters; and
replace the pixel values in each defect map with the corresponding filtered image pixel values.

37. The digital image acquisition system of claim 36 where, the computer readable code that causes the at least one digital processor to correct the values of the pixels in each defect map further causes the at least one digital processor to:
interpolate the value at each pixel in each defect map from neighboring pixel values, said neighboring pixels being located in said defect map, the region of interest corresponding to said defect map, or the input digital image.

38. The digital image acquisition system of claim 37 where, the computer readable code that causes the at least one digital processor to interpolate the value at each pixel in each defect map includes utilizing coring means.

39. The digital image acquisition system of claim 34 where the computer readable code that causes the at least one digital processor to adjust the values of the pixels in each region of interest further causes the at least one digital processor to:
filter the input digital image with a median filter to generate a filtered image, said filtered image comprised of a plurality of filtered image pixels, each pixel having at least one given value selected from at least one of a plurality of image description parameters; and
replace the pixel values in each defect map with the corresponding filtered image pixel values; perform a smoothing operation to obtain the adjusted value of the pixels in each region of interest corresponding to each defect map, said smoothing operation being performed on the pixel values of said region of interest and on the pixel values of neighboring pixels, said neighboring pixels being located in said defect map, said region of interest, or the input digital image.

40. The digital image acquisition system of claim 39 where the computer readable code that causes the at least one digital processor to perform a smoothing operation to obtain the adjusted value of the pixels in each region of interest includes utilizing coring means.

41. The digital image acquisition system of claim 34 where the computer readable code that causes the at least one digital processor to generate a region of interest for each defect map includes utilizing a dilation operator.

42. The digital image acquisition system of claim 35 where, the computer readable code further causes the at least one digital processor to:
identify second iteration defects, after correcting the values of the pixels in each defect map and adjusting the values of the pixels in each region of interest, to form at least one of a plurality of second iteration defect maps, said second iteration defect maps comprised of second iteration defect pixels, said second iteration defect pixels being corrected and adjusted image pixels, said identification utilizing a second iteration threshold; and
generate a second iteration region of interest for each second iteration defect map, said second iteration region of interest surrounding the entire perimeter of said corresponding second iteration defect map, each said region comprised of second iteration region of interest pixels, said second iteration region of interest pixels being corrected and adjusted image pixels; and
correct the values of the pixels in each second iteration defect map; and
adjust the values of the pixels in each second iteration region of interest.

43. The digital image acquisition system of claim 34 where, the computer readable code further causes the at least one digital processor to:
define, prior to generating a region of interest for each defect map and based on input from a user, at least one area of the input digital image as a selected area;
and, where said at least one digital processor does not generate a region of interest in said selected areas, and does not correct the values of the pixels in each defect map for pixels in said selected areas.

44. The digital image acquisition system of claim 34 where, the computer readable code that causes the at least one digital processor to identify the defects to form at least one defect map further causes the at least one digital processor to:
identify at least one point as a defect, said points defining the defect pixels, said identification being based on input from a user.

45. The digital image acquisition system of claim 35 where, the computer readable code that causes the at least one digital processor to identify the defects to form at least one defect map further causes the at least one digital processor to:
identify at least one point as a defect, said points defining the defect pixels, said identification being based on input from a user.

46. The digital image acquisition system of claim 34 where, the computer readable code further causes the at least one digital processor to:
display, prior to generating a region of interest for each defect map and based on input from a user, the identified defect maps superimposed on the input digital image, forming a defect map display image.

47. The digital image acquisition system of claim 46 where, the computer readable code further causes the at least one digital processor to:
select, prior to generating a region of interest for each defect map and based on input from a user, an area of the defect map display image, said selected area being an area of observation; and display, upon receipt of a display command from a user, a section of the input digital image located under the defect map display image in said area of area of observation.

48. The digital image acquisition system of claim 46 where, the computer readable code further causes the at least one digital processor to:
select, prior to correcting the values of the pixels in each defect map, at least one defect point from the defect map display image, said selected points being precluded from being corrected.

49. The digital image acquisition system of claim 48 where, the computer readable code further causes the at least one digital processor to:
remove said selected points from each corresponding defect map.
